(19) United States
(12) Patent Application Publication
(10) Pub. No.: US 2016/0227732 A1
(43) Pub. Date: Aug. 11, 2016

(54) Pet Harness for Connecting to an Automobile Seat Belt Connector

(71) Applicant: Eric Maurice Pompey, Monterey, CA (US)

(72) Inventor: Eric Maurice Pompey, Monterey, CA (US)

(21) Appl. No.: 14/884,627

(22) Filed: Oct. 15, 2015

Related U.S. Application Data
(60) Provisional application No. 62/114,940, filed on Feb. 11, 2015.

(51) Int. Cl. A01K 1/02

(52) U.S. Cl. CPC A01K 1/0263

(57) ABSTRACT

A device for conveniently and safely harnessing a pet to a standard seat belt receiver of a vehicle. The device includes a latching member that configured to be received and latched into a standard seatbelt receiver of a vehicle. The latching member can be pivotally connected with a housing so that it can be pivoted outward for attachment to the seatbelt receiver and pivoted back in when not in use. The device also includes a leash re-wind mechanism that maintains a constant tension on the leash during normal use and that locks extension of the leash when a sudden, abrupt extension of the leash occurs.

### PRIORITY CLAIM

This Application claims priority to Provisional Patent Application 62/114,940, entitled METAL DEVICES THAT ATTACH TO THE HOUSINGS OF AUTOMATIC PET LEASHES OR FIXED TYPE LEASHES, filed Feb. 11, 2015, Which is incorporated herein by reference.

### TECHNICAL FIELD

The present invention relates to pet restraint, and more particularly, to a pet leash configured for connection to a vehicle seat-belt connector.

### BACKGROUND OF THE INVENTION

Many pet owners enjoy travelling with their pets. Often, traveling with pets becomes a necessity when a pet owner needs to be away from home and when pet-sitting services are not available. While traveling with pets can be enjoyable, it does present its own unique set of challenges. Pets that are loose in a car, for example, can interfere with driving causing a dangerous situation, not only for the pet and owner, but also for others sharing the road with the owner.

Some owners of vehicles such as light trucks may opt to let their pets ride in the back or “bed” of the truck. However, while this prevents the pet from interfering with the driver, it present its own particular risks to the pet, such as the risk that the pet might be inadvertently ejected from the bed of the truck during a traffic maneuver or accident. In order to protect pets and drivers some municipalities have actually enacted laws requiring pets to be restrained when in a vehicle, especially when riding in the bed of a truck.

However, proper restraint of pets in vehicles presents challenges. For example, finding an easy secure attachment for a pet leash can be challenging, Automobiles are provided with safety restraints that are designed to accommodate humans, but which are not suitable for restraining pets. In addition, if a leash attachment point is found, there will inevitably be a certain amount of slack in the leash in order to provide the pet with a humane amount of mobility. In an accident or abrupt stop, however, this slack will allow the pet to be projected forward and then suddenly jerked to a stop when the slack in the leash has run out. This can lead to serious injury to the pet. Accordingly, there remains a need for an apparatus that can conveniently and safely restrain a pet while traveling.

### SUMMARY OF THE INVENTION

The present invention provides a device for harnessing a pet to a standard seatbelt receiver of a vehicle. The device includes a housing, a leash re-wind mechanism mounted within the housing, and a latching member connected with the housing. The latching member is configured to be received and latched into a seat belt receiver of a vehicle.

The harnessing device includes a latching member that can be pivotally connected with a housing so that it can be pivoted outward to be inserted into a seatbelt receiver and then pivoted inward to rest against a side of the housing when not in use,

A handle can be attached to the housing to facilitate ease of use, both when the device is used as a harness in the vehicle and when the device is used as a leash outside of the vehicle. A release button can be provided on the handle to control the re-wind mechanism as desired,

The rewind mechanism advantageously ensures safety of the pet when harnessed into the vehicle. The re-wind mechanism provides a constant tension on the leash, while also allowing the pet a certain amount of mobility when harnessed in the vehicle.

In the event of a sudden extension of the leash such as in the case of an automobile accident or sudden braking, the re-wind mechanism locks in place to prevent further extension of the leash. The constant tension provided by the re-wind mechanism prevents slack in the leash so that the pet will be firmly held in place rather than propelling some distance and then being suddenly jerked to a stop as would be the case if a fixed length leash were to be used.

The device also advantageously facilitates loading and unloading of the pet in to the vehicle. For example, when loading the pet into the vehicle, the device is simply clicked into the seatbelt receiver with the owner holding the handle of the device. Then, when the time comes to remove the pet from the vehicle, the owner can simply grasp the handle of the device and disconnect it from the seatbelt receiver. Because the re-wind mechanism provides a constant tension on the leash and locks in place if it is suddenly extended, the pet can be well controlled during removal of the pet. This advantageously prevents the pet from inadvertently jumping out of the car and running for some distance until the leash slack has been taken up, thereby preventing injury to the pet or the owner.

Consequently, for a better understanding of the present invention, its functional advantages and the specific objects attained by its uses, reference should be made to the accompanying drawings, claims and descriptive matter in which there are illustrated preferred embodiments of the invention.

### BRIEF DESCRIPTION OF THE DRAWINGS

For a fuller understanding of the present invention, reference is made to the accompanying drawings numbered below. Commonly used reference numbers identify the same or equivalent parts of the claimed invention throughout the several figures.

FIG. 1 is a perspective view of a pet harness device;

FIG. 2 is a second perspective view of the pet harness device of FIG. 1;

FIG. 3 is an exploded perspective view of the pet harness of FIGS. 1 and 2 shown in relation to an automobile seat belt harness;

FIG. 4 is a view of the pet harness device attached to a seat belt receiver of an automobile; and

FIG. 5 is a perspective view of a pet harness device according to another embodiment of the invention.

### DETAILED DESCRIPTION

The following detailed description is of the best currently contemplated modes of carrying out various embodiments of the invention. The description is not to be taken in a limiting sense, but is made for at least the purpose of illustrating the general principles of the invention, since the scope of the invention is best defined by the appended claims.

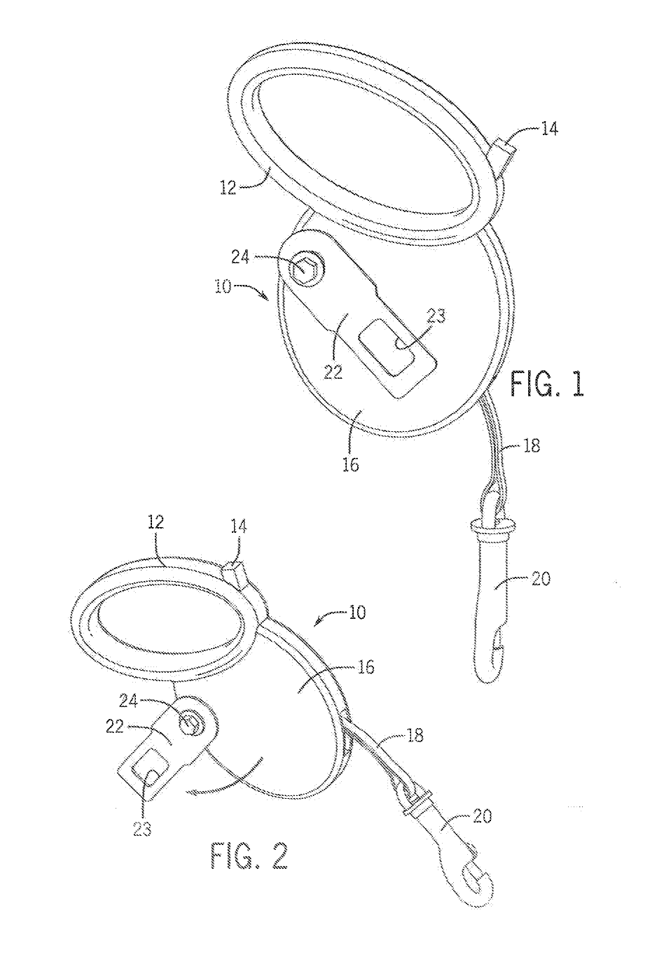

FIGS. 1 and 2 show a pet restraint assembly 10 in two different use configurations. The pet restraint assembly 10 includes a leash re-wind mechanism enclosed in a housing 16. The leash re-wind mechanism is operable to provide tension to the leash and also to lock extension of the leash 18. A handle 12 is connected with the housing for ease of use both in attaching and detaching the device 10 in a vehicle and for using the device as a standard leash outside of the vehicle.

The handle 12 can include a release button 14 that can be used to release the re-wind mechanism to retract the leash 18. The leash 18 can have a connector such as a slide bolt spring snap 20 at its end for easily connecting the leash 18 to a pet harness or collar. Further, the length of the leash 18 can be advantageously adjusted to accommodate different sizes of pets and/or animals.

A pivotal latching member 22 is connected with the housing 16 by a pivot bolt 24 or some other suitable attachment that allows the pivotal latching member 22 to pivot about the attachment point. In this way, the pivotal latching member 22 can be kept in a closed position engaged against the side of the housing as shown in FIG. 1 when the device 10 is to be used as a leash outside of a vehicle. However, when the device is to be latched into a vehicle, the latching member 22 can be pivoted outward to a position such as that shown in FIG. 2. In another embodiment, the latching member 22 is attached to the housing 16 by means of a pivotal attaching member for allowing the latching member 22 to pivot about the attachment point. In a further embodiment, a suitable pivotal attaching member is comprised of a pivot bolt 24 as illustrated in FIGS. 1-5.

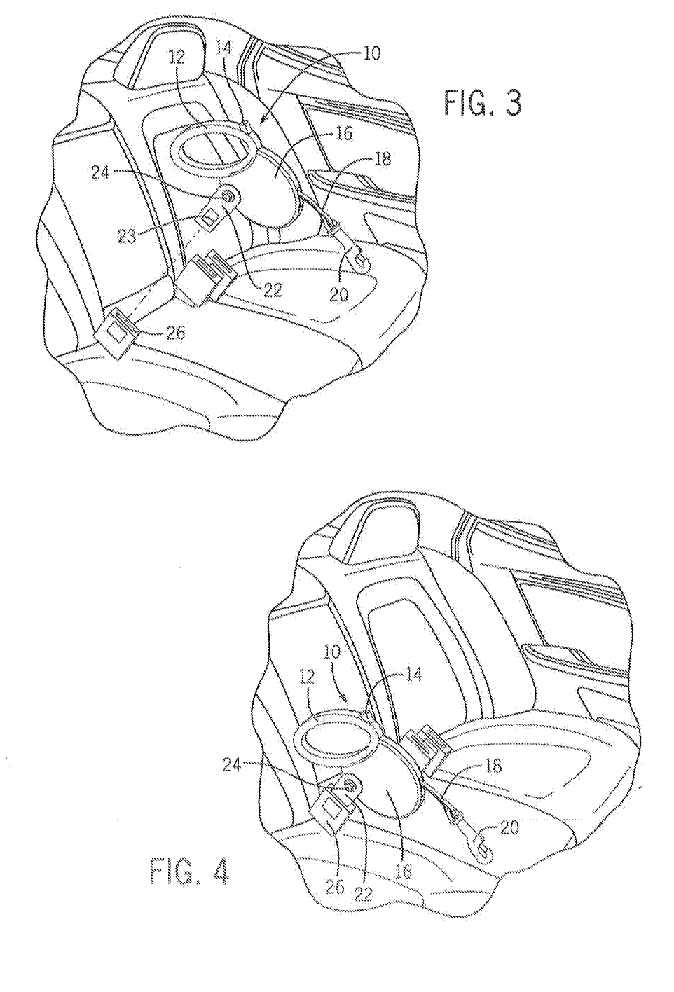

The pivotal latching member 22 has an opening 23 and is configured to be received into and latched into a standard seatbelt receiver 26, as can be seen more clearly with reference to FIGS. 3 and 4. FIG. 3 is an exploded view of the device 10 prior to being inserted into (or after being removed from) a standard seatbelt receiver 26, and FIG. 4 shows the device 10 latched into the seatbelt receiver 26.

In use, While grasping the handle 12, and with the latching member pivoted outward as shown in FIGS. 3 and 4, the device 10 can be easily connected to a seat belt connector 26 by inserting the latching member 22 into the seatbelt receiver 26 until the latching member 22 clicks into place. The pet can be attached to the connector 20 either before the device 10 has been connected with the seatbelt receiver or after.

Once in place, the leash re-winder 16 includes a pre-tensioning feature that maintains a certain amount of tension on the leash 18 while also allowing it to be extended in a controlled manner if desired. In the event of a sudden quick extension of the leash 18, the re-wind mechanism locks in place, thereby preventing further extension of the leash. This is advantageous in the present application by preventing injury to the pet. During normal use, the pre-tensioner maintains a certain amount of tension on the leash 18. This prevents the leash from having any slack, while also allowing the pet some amount of mobility. However, the leash re-winder mechanism is advantageously operable to lock in place to prevent extension of the leash in response to a sudden, abrupt extension of the leash. In this way, the re-wind mechanism locks and prevents extension of the leash when the vehicle suddenly stops such as in the event of sudden braking of the vehicle or even an accident, thereby preventing the pet from being projected through the vehicle and otherwise being injured by striking the interior of the vehicle. Additionally, the pre-tensioner, by preventing slack in the leash 18, prevents the pet from being flung some distance through the vehicle and then being suddenly jerked to a stop. This prevents injuries to the pet that might otherwise occur if a more standard, fixed length leash were used.

The device 10 also advantageously facilitates removal of the pet without injuring or losing control of the pet. When the pet is to be removed from the vehicle, the pet owner can first grasp the handle 12, and then push a button on the seatbelt receiver 26 to release the latching member 22 from the seatbelt receiver 26. This means that the owner can already be securely holding onto the device 10 before the device 10 has been released. This prevents the pet from running off (possibly into traffic) before the owner has secured control of the leash. Furthermore, because the device 10 can be used as a standard leash, the pet does not have to be transferred to a separate leash device, which would create another opportunity for the pet to run off.

In addition, the pre-tensioning of the leash 18 helps to maintain control of the pet upon exiting the vehicle. The leash 18 will remain taut in the owner's hand, preventing slack in the leash 18 that might allow the pet to run off for some distance before suddenly jerking the leash out of the owner's hand, which might not only injure the pet, but the owner as well.

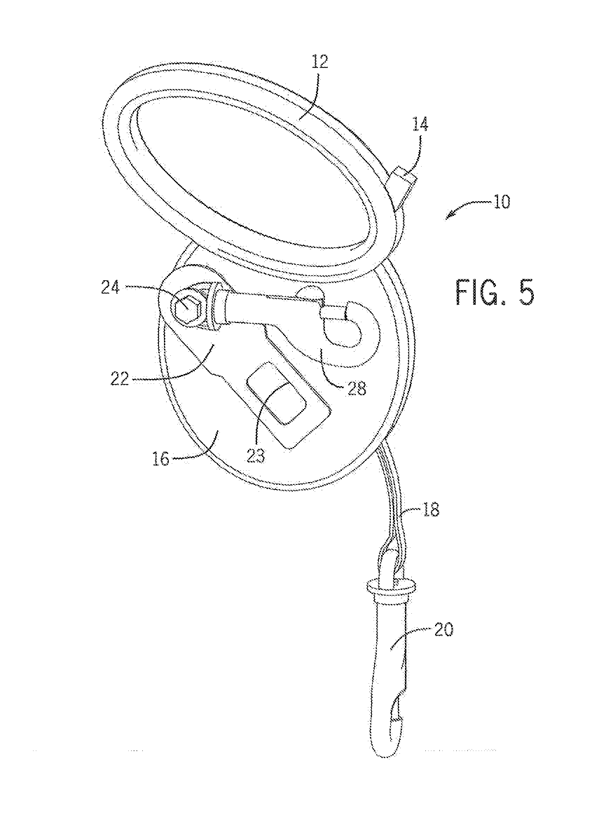

FIG. 5 shows a perspective view of a pet restraining device according to an alternate embodiment of the invention. The device of FIG. 5 is similar to that of FIGS. 1-4, except that it includes a second attachment clip 28 for connecting the device to an attachment point other than a seat belt receiver. The attachment clip 28 can be of various configurations. However, as shown in FIG. 5, the attachment clip 28 is a slide bolt spring snap clip similar to the attachment 20 described above,

The attachment clip 28 can be useful when it becomes necessary or desirable to harness a pet in a location where no seat belt receiver is conveniently available. For example, this could be useful when a pet is to be harnessed in the back bed of a truck or even in an interior cargo area of a vehicle such as in the back of a station wagon or sport utility vehicle (SUV).

In FIG. 5 the attachment clip 28 is connected with the same pivot bolt 24 that is used to attach the pivotal latching member 22 as described above. Also, similar to the pivotal latching member 22, the attachment clip 28 can pivot out to connect with a connection point and then can be pivoted back in against the sides of the housing 16 to keep it out of the way when not in use.

The present invention has been particularly shown and described with respect to certain preferred embodiments and features thereof, However, it should be readily apparent to those of ordinary skill in the art that various changes and modifications in form and detail may be made without departing from the spirit and scope of the inventions as set forth in the appended claims. The inventions illustratively disclosed herein may be practiced without any element which is not specifically disclosed herein.

What is claimed is:

1. A pet restraint, comprising;
a housing;
a leash re-wind mechanism mounted within the housing; and
a latching member connected with the housing, the latching member being configured to be received and latched into a seat belt receiver of a vehicle.

2. The pet restraint as in claim 1, wherein the latching member is pivotally connected with the housing so that it can be pivoted outward for attachment into the seatbelt receiver and pivoted inward against the housing when not in use.

3. The pet restraint as in claim 1, a release button for controlling the leash re-wind mechanism.

4. The pet restraint as in claim 1, further comprising a leash connected with the leash re-wind mechanism.

5. The pet restraint as in claim 1, further comprising a leash connected with the leash re-wind mechanism and a connector attached to an end of the leash.

6. The pet restraint as in claim 1, further comprising a handle connected with the housing.

7. The pet restraint as in claim 1, further comprising a handle connected with the housing and a release button connected with the handle, the release button being operable to control the leash re-wind mechanism.

8. The pet harness as in claim 1 wherein the leash re-wind mechanism is connected with a leash, and wherein the leash re-wind mechanism is operable to provide a constant tension to the leash during normal use and also to suddenly lock extension of the leash during an abrupt extension of the leash.

9. The pet harness as in claim 1 further comprising a secondary attachment clip connected with the housing.

10. The pet harness as in claim 9 wherein the secondary attachment clip is pivotally connected with the housing.

11. The pet harness as in claim 9 wherein the secondary attachment clip and the pivotal latching member are connected with the housing by common hardware.

12. The pet restraint according to claim 2, wherein the latching member is attached to the housing by a pivotal attaching member, thereby allowing the, latching member to pivot about the attachment point.

13. The pet restraint according to claim 12, wherein the pivotal attaching member is a pivot bolt.

14. The pet restraint according to claim 1, wherein the latching member includes an opening for allowing said latching member to be latched into a standard seatbelt receiver.

15. The pet restraint according to claim 1, wherein the length of the leash is adjustable to accommodate different sizes of pets.

16. A pet restraint, comprising
a housing;
a leash re-wind mechanism mounted within the housing;
a leash connected with the leash re-wind mechanism, the leash being adjustable to accommodate different sizes of pets;
latching member attached to the housing by a pivotal attaching member for allowing said latching member to pivot; and
the latching member having an opening for allowing the latching member to be received and latched into a seat belt receiver of a vehicle.

17. A pet restraint, comprising:
a housing;
a leash re-wind mechanism mounted within the housing;
a leash connected with the leash re-wind mechanism, the leash being adjustable to accommodate different sizes of pets;
a latching member attached to the housing by a pivotal attaching member for allowing said latching member to pivot;
the latching member having an opening for allowing the latching member to be received and latched into a seat belt receiver of a vehicle; and
a secondary attachment clip connected with the housing by the pivotal attaching member for allowing the secondary attachment clip to pivot and for allowing the pet restraint to connect to an attachment point other than the seat belt receiver.
